(19) United States
(12) Patent Application Publication
(10) Pub. No.: US 2015/0016906 A1
(43) Pub. Date: Jan. 15, 2015

(54) Drill Bit System and Method for Forming Holes in Materials

(71) Applicant: Colleen F. York, Algonquin, IL (US)

(72) Inventor: Colleen F. York, Algonquin, IL (US)

(21) Appl. No.: 14/490,967

(22) Filed: Sep. 19, 2014

Related U.S. Application Data
(63) Continuation-in-part of application No. 12/660,361, filed on Feb. 25, 2010, now abandoned.
(60) Provisional application No. 61/894,712, filed on Oct. 23, 2013.
(60) Provisional application No. 61/982,909, filed on Apr. 23, 2014.

(51) Int. Cl. B23B 51/02; B23B 51/12; B23B 51/08

(52) U.S. Cl. CPC B23B 51/02; B23B 51/08; B23B 51/126; B23B 2240/00; B23B 2251/02; B23B 2260/124; B23B 2260/068
USPC 408/1 BD; 408/226

(57) ABSTRACT

A drill bit system and associated methodology enables a user to quickly and easily interchange drill bits upon a primary shank during drilling operations. The drill bit system optionally comprises a primary, flexi-shank, a series of drill bits, a set screw, an extension adapter, and quick change or secondary shank. The primary shank has a notched, bit-engaging end. Each drill bit has a shank-engaging end and a bit axis. Each shank-engaging end has female structure for receiving the bit-engaging end. Each female structure has a substantially uniform inner bit diameter sized for receiving the shank. The bit-engaging end is receivable by the shank-engaging ends, and the set screw is threadably receivable by both (a) threaded apertures formed in the bits and (b) the notch for removably and interchangeably fastening the drill bits to the flexi-shank. The extension adapter and secondary, quick change shank enable added interchangeability and drilling capabilities.

### BACKGROUND OF THE INVENTION

1. Prior History

This application claims the benefit of (1) pending U.S. patent application Ser. No. 12/660,361 filed in the United States Patent and Trademark Office on 25 Feb. 2010, which application claimed the benefit of expired U.S. Provisional Patent Application No. 61/182,855, filed in the United States Patent and Trademark Office on Jun. 1, 2009; (2) pending U.S. Provisional Patent Application No. 61/894,712 filed in the United States Patent and Trademark Office on 23 Oct. 2013; and (3) pending U.S. Provisional Patent Application No. 61/982,909 filed in the United States Patent and Trademark Office on 23 Apr. 2014.

2. Field of the Invention

The present invention generally relates to a drill bit system or assembly for forming holes in and installing lines through various types of materials. More particularly, the present invention relates to a drill bit system or assembly configured for quick and easy set screw-based interchangeability of drill bits upon a single, elongate, flexible shank for boring through a variety of materials having a bore depth greater than the length of the individual drill bits.

3. Description of Prior Art

U.S. Pat. No. 597,750 ('750 Patent), which issued to Smith, discloses an Auger Bit. The '750 Patent describes a bit or auger for use in wiring buildings, composing a shank and head, the head being of greater diameter than the shank throughout its length, and being provided with two spiral grooves which extend throughout its length, from the smaller diameter of the shank adjacent to the head to the cutting point and a plurality of transverse perforations or openings formed in the head, by which said grooves are connected, substantially as shown and described. U.S. Pat. No. 2,958,349 ('349 Patent), which issued to McNutt, discloses a Curved Extension Drill. The '349 Patent describes a tubular outer sleeve which is bent intermediate its ends, a bit within it lower straight portion, an inner sleeve bearing slidably mounted in the upper straight portion, and a flexible shaft connecting the bit and the slidable bearing. The straight portions of the sleeve define an included angle of approximately 135 degrees. The lower end of the outer sleeve is notched for chip clearance. The bit shank is rotatably and slidably received in a bearing located in the lower end of the sleeve immediately above the recess.

As shown in FIG. 2 of the '349 Patent, the bearing is detachably secured in place by means of a set screw threadably engaged in and extending through the sleeve and into a recess in the side of the bearing. The shank of the bit is connected with the lower end of the flexible shaft by means of a set screw threadably positioned through the side of the tubular adapter, the outside diameter of said adapter being slightly less than the inside diameter of said sleeve, and which set screw extends into a recess in the upper end of said bit shank which is slidably received within said tubular adapter. The set screw is accessible through an opening in the side of the sleeve.

U.S. Pat. No. 3,611,549 ('549 Patent), which issued to Pope, discloses a Method for Forming Holes in and Installing Lines in Structural Members. The '549 Patent describes a method for forming holes for electrical conductor lines and the like in structural frame members of a hollow wall by utilizing a drill having an elongate spring-like shaft with a drill bit on its leading end. The shaft may be bowed to insert the same into the all to direct the drill bit in the desired direction. U.S. Pat. No. 3,697,188 ('188 Patent), issued to Pope, further discloses an Apparatus for Forming Holes in and Installing Lines in Structural Members.

U.S. Pat. No. 3,915,245 ('245 Patent), which issued to Tuccillo, discloses a Test Boring Drill Bit. The '245 Patent describes the ball which is removed from the tubular coring device of FIG. 1 and a bit attached to the coring device by means of the set screw making sure that the handle is in a position of vertical to right of vertical as shown in position A of FIG. 8. The assembly is connected to the drill pipe and lowered to drilling elevation. The drilling fluid is connected to the top of the drill pipe and drilling is started.

U.S. Pat. No. 4,033,703 ('703 Patent), which issued to Slater, discloses a Drill Bit for Coupling to a Wire Fishing Adapter. The '703 Patent describes a drill adapted to be detachably and pivotably linked to a wire fishing adapter for pulling wiring through a bored-out passage in a wall or the like, including a blade-type drill bit having a pin protruding from one of the faces of the drill bit blade, a rod having a pair of spaced-apart apertured fingers at one end and having a conically-shaped receptacle at the opposite end for lockable engagement with the end of a wire.

U.S. Pat. No. 4,218,795 ('795 Patent), issued to Ernst et al., discloses a Drill Bit with Fastener-Driving Collar Assembly. The '795 Patent describes a two piece hole-drilling and fastener-driving assembly consists of a three-sectioned drill bit and a three-sectioned drive collar. The drill bit has a fluted drilling section, a hexagonal driving section and a tapered section adapted to be received in a complementarily shape chuck of a rotary hammer. The drive collar has a first hexagonal portion which mates with the hexagonal drill bit section and is driven thereby.

A second tubular portion receives the drilling section when the hexagonal portions are engaged. A third portion includes a fastener-engaging recess. This portion may take the form of a removable socket and the collar provided with a spring-biased ball retainer to hold the socket thereon and a second such retainer to hold the collar on the drill bit. The drill bit is inserted in the rotary hammer chuck and a hole is drilled in the work piece. The drive collar is then slipped over the drill bit and a self-tapping fastener driven into the just-drilled hole.

U.S. Pat. No. 6,485,235 ('235 Patent), issued to Mast et al., discloses a Cutting Tool Assembly with Replaceable Cutting Head. The '235 Patent describes a cutting tool assembly comprising a replaceable cutting head and a tool body having a common longitudinal axis and mating peripheral surfaces. The cutting head has a cutting portion forming a leading end, a pilot portion forming a trailing end, and a cutting head mounting portion adjacent the trailing end of the cutting head. The tool body has a cutting head receiving portion formed at a leading end of the tool body and a pilot recess disposed in the leading end of the tool body to matingly receive the pilot portion of the cutting head. The cutting head mounting portion and the cutting head receiving portion of the tool body each have at least two coupling portions.

The cutting head coupling portions and the tool body coupling portions are bound by their peripheral surfaces and generally mate in shape and dimensions. Each coupling portion has a pair of base surfaces, including upper and lower surfaces. The base surfaces extend transversely to the longitudinal axis and provide support of the cutting head in the tool body. A torque transmission wall extends between the upper and lower base surfaces from the pilot portion surface in a generally transverse direction relative to the longitudinal axis and oriented transversely to the base surfaces. A fastener may be disposed in the tool body along its longitudinal axis where it matingly engages the pilot portion of the cutting head and exerts an axial force on the cutting head for pressing the cutting head mounting portion against the cutting head receiving portion of the tool body.

U.S. Pat. No. 7,131,790 ('790 Patent), which issued to Cordoves, discloses a Boring and Conduit/Pipe System. The '790 Patent describes an extension rod having an interior end and an exterior end. The exterior end is formed with male screw threads. A primary bit has a cylindrical interior end and a conical exterior. Female threads at the interior end releasably couple with the extension rod. A secondary bit has a cylindrical interior end and a conical exterior end. Female threads at the interior end releasably couple with the extension rod. A length of line is coupled to the exterior end of the secondary bit. A coupler has a rearward end couplable to a linear member. A forward end is couplable to the rearward end of the secondary bit. In this manner the line, secondary bit and linear member may be pulled through the bore hole.

U.S. Pat. No. 7,435,042 ('042 Patent), which issued to White et al., discloses a Flexible and Extendable Drill Bit Assembly. The '042 Patent describes a flexible, extendable extension assembly used to create extended length holes and holes through inaccessible areas in walls and framing. The extension assembly including a flexible rod having first and second ends; and a holding means secured to the first end of the rod for releasably holding a tool bit for rotation with the rod.

U.S. Patent Application Publication No. 2002/0009342, authored by Vasudeva, describes two-piece drill bit(s) having a preferably hexagonal shank, and a drill portion having a proximal end inserted into an axial hole in a distal end of the shank. In a preferred embodiment, at least part of the area adjacent the proximal end of the drill portion is knurled. Alternative embodiments have wings, polygons, tapers or other irregular shapes, or combinations of same. A variety of means are employed to mechanically capture the drill portion in the shank.

U.S. Patent Application Publication No. 2005/0186043, authored by Fuller, describes a method and assembly for mounting a drill bit into a shank for allowing the drill bit to be integrated into a modular adapter system. Further disclosed are certain mounting means for installing a drill bit into a shank that wherein the drill bit is aligned with the axis of rotation of the shank while also including features that provide for positive retention of the drill bit, superior resistance to twist out and the ability to replace the drill bit as it becomes worn or breaks.

It will thus be seen that holes for electrical conductor lines and the like through structural members are commonly drilled using an apparatus consisting of a specialized drill bit fastened to a spring steel shank. Due to the diversity of building materials a worker encounters and the many different length requirements in a construction project, a worker must purchase several different styles and lengths of elongate drill bits, which can be very costly.

Certain attempts have been made and several products currently exist that have an interchangeable bit but due to the diameter of their connecting device these devices can only be used with large ¾ inch or larger bits and ¼ inch shanks. In addition, some have been introduced with a connection consisting of an internal and external thread to join the drill bit and the shank together. This application is not feasible due to the operation of the apparatus requires in some cases to operate in reverse, causing the drill bit to unthread and become lost in the wall.

The prior art thus perceives a need for an improved drill bit assembly having interchangeable drill bits of several types and sizes specially manufactured with a threaded hole accepting a set screw at a right angle to the tapered portion of the shank of the drill bit and a specially manufactured spring steel shank with a groove to accept the set screw passing through the drill bit shank that would allow for the use of all diameters (⅜ inch to 1 inch bits), all types (wood, steel, and masonry bits), and 3/16 inch and ¼ inch spring steel shanks, as described in more detail hereinafter.

### SUMMARY OF THE INVENTION

The present invention essentially provides a drill bit system and associated methodology for enabling a user to quickly and easily interchange drill bits upon a select shank construction during drilling operations for selectively extending the drillable depth through select materials. The drill bit system and method according to the present invention is believed to preferably comprise, in combination, a primary shank; at least two interchangeable select drill bits; and a set screw or similar other fastening device.

The primary shank has a bit-engaging end, a shank length, and a rotary source-engaging end. The bit-engaging end has a shank tip and a notched portion adjacent the shank tip. The shank length extends intermediate the bit-engaging end and the rotary source-engaging end. The shank tip and shank length have a substantially uniform shank diameter, and the shank tip has a specific tip width extending intermediate the bit-engaging end and the notched portion. The notched portion has a notch width and a specific notch depth.

Each select drill bit has a bit tip, a flute portion, a shank-engaging portion, and a bit axis. Each flute portion has a maximum flute diameter. Each shank-engaging portion has a shank-engaging end, an outer portion surface, an inner bit-based female structure for receiving the bit-engaging end of the shank, a threaded or fastener-receiving aperture, and a shank-receiving mouth. Each shank-engaging end has a shank end diameter. Each threaded or fastener-receiving aperture respectively extends from the outer portion surface to the inner bit-based female structure orthogonally relative to the bit axis for defining an inner aperture extent and an outer aperture extent.

Each inner bit-based female structure has a substantially uniform inner bit diameter sized for receiving the shank diameter and a shank-stopping terminus. The shank-stopping terminus is spaced from the inner aperture extent a distance equal to the tip width. Each maximum flute diameter is respectively greater than each shank end diameter and the shank diameter. Each outer portion surface is tapered from the maximum flute diameter to the shank end diameter.

The set screw of similar fastener device has a notch-engaging end, a tool-engaging end, and a threaded body extending intermediate the notch-engaging and tool-engaging ends, the threaded body having a maximal screw diameter, the notch width being sized for receiving the maximal screw diameter, the bit-engaging end being receivable by the shank-engaging ends, the set screw being threadably receivable by the threaded apertures, the notch-engaging end being receivable by the notched portion, the set screw thus for removably and interchangeably fastening the drill bits to the shank, the tip width being greater than the notch depth for minimizing torque-induced shank failure at a set screw-to-shank junction via the threaded aperture, the maximum flute diameters for enabling the user to bore into materials for forming material voids therein, the material voids having void diameters substantially and respectively equal to the maximum flute diameters, each tapered outer bit surface from the maximum flute diameter to the shank end diameter for enabling an entire select drill bit to pass through the material voids, and the shank diameter thus also being lesser than the void diameters, the shank length for selectively extending the drillable depth through said materials.

### BRIEF DESCRIPTION OF THE DRAWINGS

Other features of my invention will become more evident from a consideration of the following brief description of patent drawings:

FIG. 1 is an exploded side view of a fragmentary shank, a first drill bit, and a set screw according to the present invention.

FIG. 1(a) is an enlarged, fragmentary view of the shank tip otherwise depicted in FIG. 1.

FIG. 2 is a side view of a fragmentary shank, a second drill bit, and a set screw as assembled according to the present invention.

FIG. 3 is an enlarged fragmentary view of a shank-engaging end of a drill bit according to the present invention showing orthogonal female structure for receiving a bit-engaging end and a set screw.

FIG. 4 is an enlarged fragmentary view of a bit-engaging end of a shank and a set screw inserted into the shank-engaging end otherwise shown in FIG. 3.

FIG. 4(a) is an enlarged fragmentary perspective view of a set screw exploded from a shank-engaging end of a drill bit according to the present invention.

FIG. 5 is an exploded side view of a third drill bit and a set screw according to the present invention.

FIG. 6 is an exploded side view of a fourth drill bit and a set screw according to the present invention.

FIG. 7 is an exploded side view of a fifth drill bit and a set screw according to the present invention.

FIG. 8 is a side view type depiction of the drill bit assembly according to the present invention outfitted with a first drill bit for drilling wood drilling through a fragmentary wooden structure.

FIG. 9 is a side view depiction of the first drill bit otherwise shown in FIG. 6 being interchanged with a second drill bit for drilling through masonry.

FIG. 10 is a side view depiction of the drill bit assembly according to the present invention outfitted with the second drill bit otherwise shown in FIG. 7 drilling through a fragmentary masonry structure.

FIG. 11 is a side perspective type depiction of the drill bit assembly according to the present invention drilling through a series of structural members as juxtaposed adjacent a prior art adapter assembly drilling through a first of the structural members.

FIG. 12 is an enlarged fragmentary depiction of the portions of the subject matter otherwise presented in FIG. 8, enlarged for further clarity of inspection.

FIG. 13 is an enlarged fragmentary depiction of the portions of the subject matter otherwise presented in FIG. 10, enlarged for further clarity of inspection.

FIG. 14 is a perspective type diagrammatic depiction of a rotary source connected to the rotary source-engaging end of a flexible primary shank depicting a drilling operation underneath a sidewalk construction.

FIG. 15 is a cross-sectional diagrammatic depiction of a flexible primary shank directed non-linearly through earthen materials in adjacency to a sidewalk construction.

FIG. 16 is a longitudinal cross-sectional depiction of a first alternative extension adapter device according to the present invention.

FIG. 17 is a longitudinal cross-sectional depiction of a second alternative extension adapter device according to the present invention.

FIG. 17(a) is an end view of the second alternative extension adapter device according to the present invention.

FIG. 18 is a longitudinal diagrammatic depiction of a primary shank according to the present invention.

FIG. 18(a) is an end view of the second alternative extension adapter device according to the present invention.

FIG. 18(b) is an enlarged, fragmentary view of the shank tip otherwise depicted in FIG. 18.

FIG. 19 is an exploded view of an extension adapter device according to the present invention exploded from a quick change secondary shank according to the present invention.

FIG. 20 is an exploded view of an extension adapter device according to the present invention exploded from a primary shank according to the present invention.

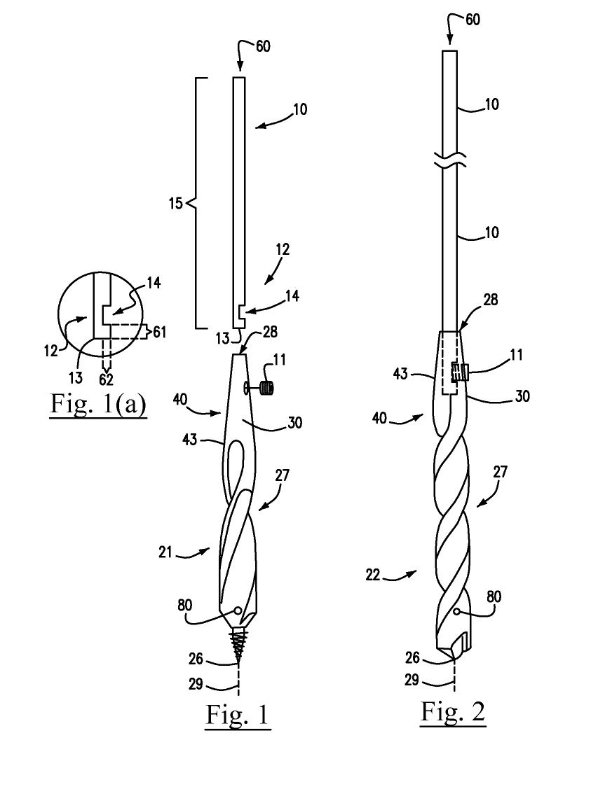

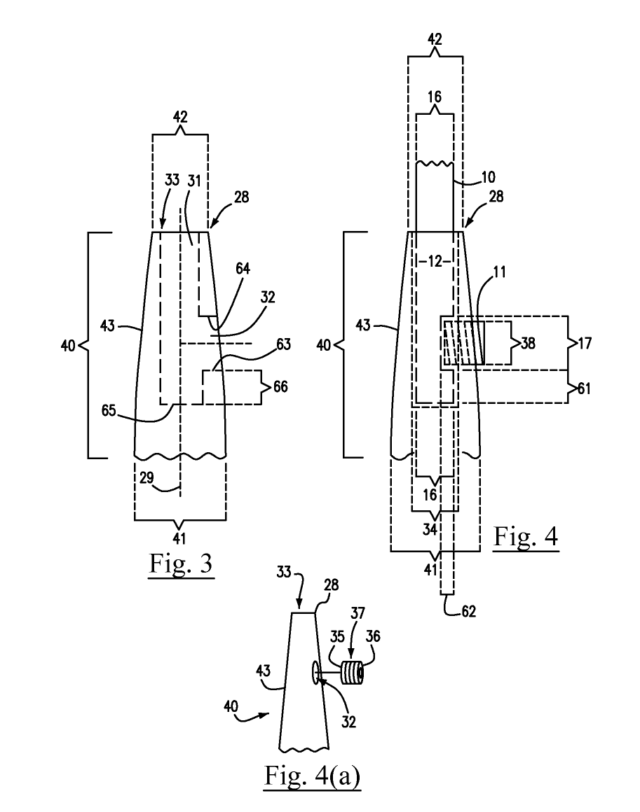

### DETAILED DESCRIPTION OF THE PREFERRED EMBODIMENT(S)

Referring now to the drawings with more specificity, the present invention essentially provides a drill bit system for enabling a user to quickly and easily interchange select drill bits upon a flexible shank during drilling operations. It is noted that during drilling operations, a worker will often encounter layered or adjacent structures of differing materials through which a bore hole must be formed. State of the art flexible drill bits are commonly of integral or permanently fastened construction rendering the interchangeability of drill bits cumbersome and costly.

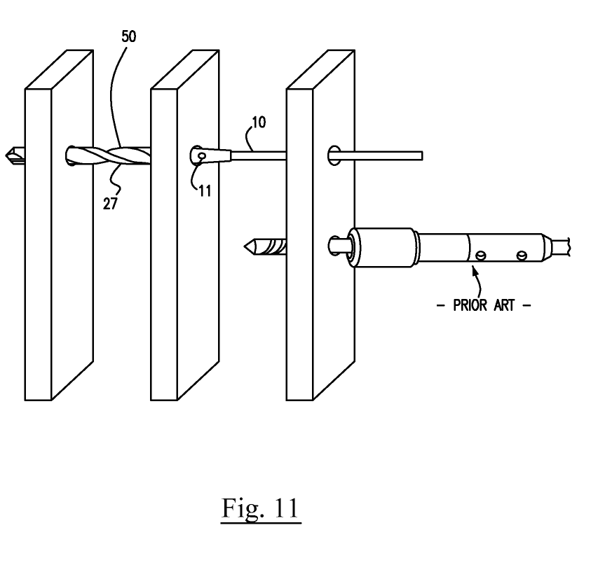

Further, prior art adapter assemblies, such as the adapter assembly shown in U.S. Pat. No. 7,435,042 (and generally depicted in FIG. 11 as juxtaposed adjacent a drill bit assembly 50 according to the present invention) typically comprise outer diameters that are too large to pass through smaller diameter holes. Larger diameter drill bits have to be used in order for these types of adapters to be useful as may be gleaned from a general inspection and consideration of FIG. 11.

In other words, adapters on the market today can only be used with 0.75 inch and larger drill bits limiting the adapter's usefulness, since most building codes require a much smaller hole (0.375 inch diameter to 0.5625 inch diameter) for installing the most common cable. A noted further problem with adapters is that when adapters of the type shown in FIG. 11 rotate at high speeds inside blind areas, they tend to release the drill bit inside the wall. Constructing the drill bits in such a way as to incorporate the adapter into the flexible shank of the drill bit assembly allows any drill bit size (0.375 inch and larger) to be used.

In an attempt to remedy the problems commonly associated with state of the art flexible drill bit systems, the drill bit system according to the present invention preferably comprises, in combination, a primary, elongate, flexible shank 10, a series of interchangeable select drill bits, and a set screw 11 or similar fastener. The primary flexible shank 10 has a bit-engaging end as at 12, a shank length as at 15, a rotary source-engaging end as at 60, and a shank-based fish hole as at 81 for enabling easy retrieval of wire via a pull device as generically depicted and referenced at 82.

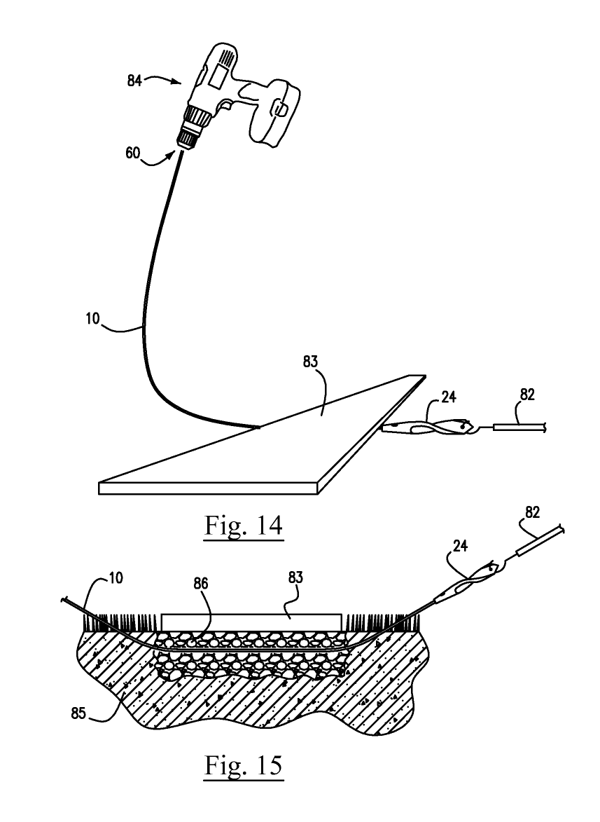

The primary, flexible shank 10 is preferably pre-heat-treated for allowing optimum flexibility and memory for drilling non-linearly through a variety of select materials as generally depicted in FIGS. 14 and 15, which figures depict a drilling operation underneath a sidewalk construction as at 83. A rotary source 84 such as a drill is attached to the rotary source-engaging end 60, which source 84 imparts rotation to the primary shank 10 and attached select drill bit as at 24, which (earthen auger type) drill bit 24 is designed for drilling through earthen materials such as soil as at 85 or aggregate as at 86.

The bit-engaging end 12 preferably comprises a shank tip 13 and a notched portion 14 adjacent the shank tip 13. The shank length 15 (e.g. 15 inches (or 38.1 cm); 21 inches (or 53.34 cm); 33 inches (or 83.82 cm); 51 inches (or 129.54 cm); and 69 inches (or 175.26 cm) extends intermediate the bit-engaging end 12 and the rotary source-engaging end 60. The shank tip 13 and shank length 15 preferably comprise a substantially uniform outer shank diameter as at 16, which shank diameter 16 is preferably formed in one of two select specifications, namely, 0.1875 inches (0.4763 cm) or 0.250 inches (0.635 cm). Further, the shank tip 13 preferably comprises a specific tip width as at 61, which tip width 61 extends intermediate the bit-engaging end 12 and the notched portion 14. The notched portion 14 preferably comprises a substantially uniform notch width as at 17 and a specific notch depth as at 62.

It is contemplated that any number of drill bits (i.e. cable bits or flex bits) may be specifically manufactured to meet the specifications of the present invention. In this regard, the drawings show a screw point drill bit as at 21, a high speed drill bit as at 22, a masonry drill bit as at 23, a wood drill bit as at 25, and an earthen auger type drill bit as at 24. Each select drill bit according to the present invention or usable in combination with the flexible or flex-shank 10, preferably comprises a bit tip as at 26, a flute portion as at 27, a shank-engaging portion as at 40, a bit axis as at 29, and a fish hole as at 80 for enabling easy retrieval of wire via a wire pull grip device 82 as generally depicted in FIGS. 14 and 15.

Each flute portion 27 preferably comprises a maximum flute diameter as at 41. Each shank-engaging portion preferably comprises a shank-engaging end as at 28. Each shank-engaging end 28 preferably has or comprises a shank end diameter as at 42.

Notably, each shank-engaging portion 40 preferably comprises a tapered outer bit surface as at 43, an inner bit-based female structure 31 for receiving the bit-engaging end 12, a fastener-receiving, preferably threaded, aperture as at 32, and a shank-receiving mouth 33 at the shank-engaging end 28. Each fastener-receiving aperture 32 preferably and respectively extends from the tapered outer bit surface 43 to the inner bit-based female structure 31 orthogonally relative to the bit axis 29 for defining an inner aperture extent as at 63 and an outer aperture extent as at 64.

Each inner bit-based female structure 31 preferably has a substantially uniform inner bit-receiving diameter as at 34 sized for receiving the shank diameter 16 and a shank-stopping terminus as at 65. In view of the fact that the shank diameters are preferably either 0.1875 inches (0.4763 cm) or 250 inches (0.635 cm), the inner bit-receiving diameters are preferably formed to respectively have select dimensions of either 0.190+0.002−0.000 inches (0.4826+0.0051−0.000 centimeters) or 0.253+0.002−0.000 inches (0.643+0.0051−0.000 centimeters).

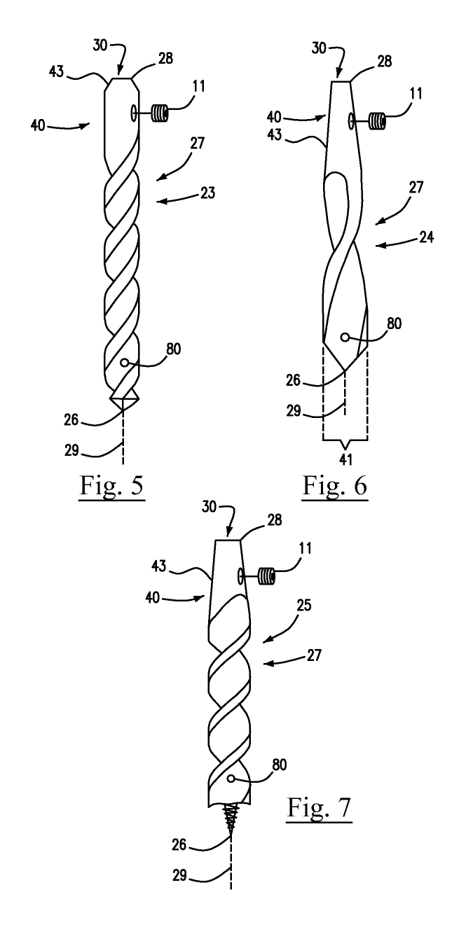

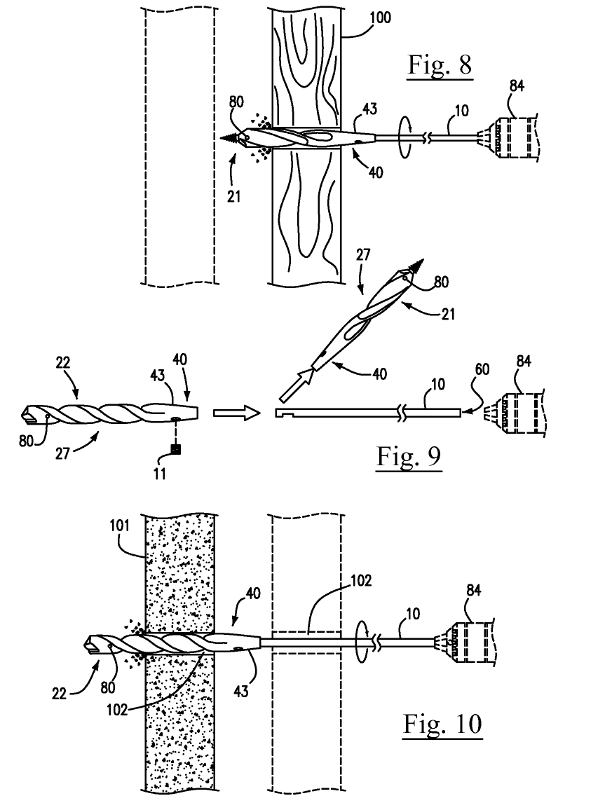

The shank-stopping terminus 65 is preferably spaced from the inner aperture extent 63 a distance 66 equal to the tip width 61. Each maximum flute diameter 41 is respectively greater than each shank end diameter as at 42 and the shank diameter 16. As indicated each outer bit surface 43 is preferably tapered or sloped from the maximum flute diameter 41 to the shank end diameter 42 as perhaps most clearly and comparatively depicted in FIGS. 4 and 5.

The set screw 11 or similar other fastening structure or means preferably has a notch-engaging end, a tool-engaging end, and a (threaded) fastener body extending intermediate the notch-engaging and tool-engaging ends. The fastener body has a maximal screw or body diameter as at 38, and the notch width 17 is preferably sized for receiving the maximal screw or body diameter 38. The bit-engaging end 12 is receivable by the shank-engaging ends 28 of the various drill bits, and the set screw 11 or similar other fastener is threadably or otherwise receivable by the fastener-receiving apertures 32 as preferably threaded. The notch-engaging end is receivable by the notch 14. The set screw 11 or similar other fastener removably and interchangeably fastens the drill bits 21 to the primary, preferably flexible shank 10.

The tip width 61 is preferably greater than the notch depth 62 for minimizing torque-induced shank failure at a fastener-to-shank or set screw-to-shank junction site via the fastener-receiving aperture 32. In this regard, excellent results have been achieved when the tip width is preferably formed to have a dimension of 0.075+0.005−0.000 inches (0.19+0.0127−0.000 cm) and the notch depth is formed to have a dimension 0.062 inches (0.157 cm).

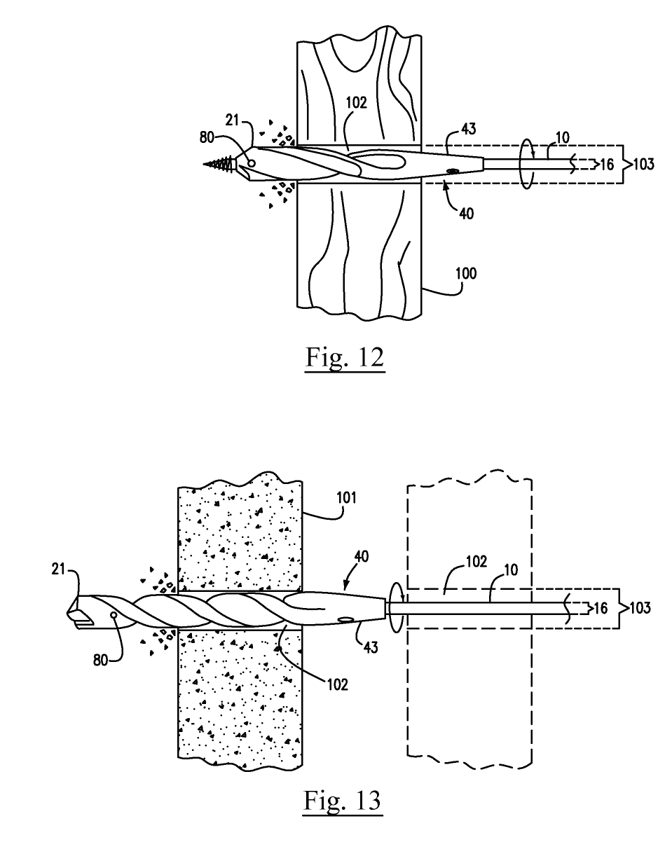

The maximum flute diameters 41 enable the user to bore into materials such as wood 100 and masonry 101 for forming material voids (as at 102) therein. The material voids 102 take on or comprise void diameters (as at 103) substantially and respectively equal to the maximum flute diameters 41. The tapered outer bit surface or surfacing 43 from the maximum flute diameter 41 to the shank end diameter 42 enables an entire select drill bit to pass through the material voids 102 in contrast to other prior art interchangeable drill bits as generally depicted in FIG. 11. The shank diameter 16, being lesser than the maximum flute diameter 41, is thus also lesser than the void diameters 103, and thus the shank length may effectively function to selectively extend the drillable depth through said materials as generally and comparatively depicted in FIGS. 11-13.

Viewed systemically, the drill bit system according to the present invention may further preferably comprise an extension adapter as at 70 (or 70′) and/or a quick change, secondary shank as at 71, which secondary shank 71 is preferably abbreviated in length relative to the primary shank 10. The extension adapter(s) 70/70′ according to the present invention preferably comprise an inner adapter-based female structure 72 identical to the inner bit-based female structure 31 as specified hereinabove. The inner adapter-based female structure 72 is identical to the inner bit-based female structure 31 so as to receive structure identical to the bit-engaging end 12.

The extension adapter(s) 70/70′ represent an improvement to the existing apparatus for drilling holes in and installing lines in structural members, and comprises a generally tubular construction having two set screws as at 74 for connecting to a three flat shank end as at 87 of a primary shank 10, and one set screw as at 75 for connecting to the notched portion(s) 14 of either the bit-engaging end 12 of the primary shank 10 or the identical structure formed on the secondary shank 71. The set screws 11, 74, and 75 are preferably fine thread set screws with nylon patches to reduce loosening during use.

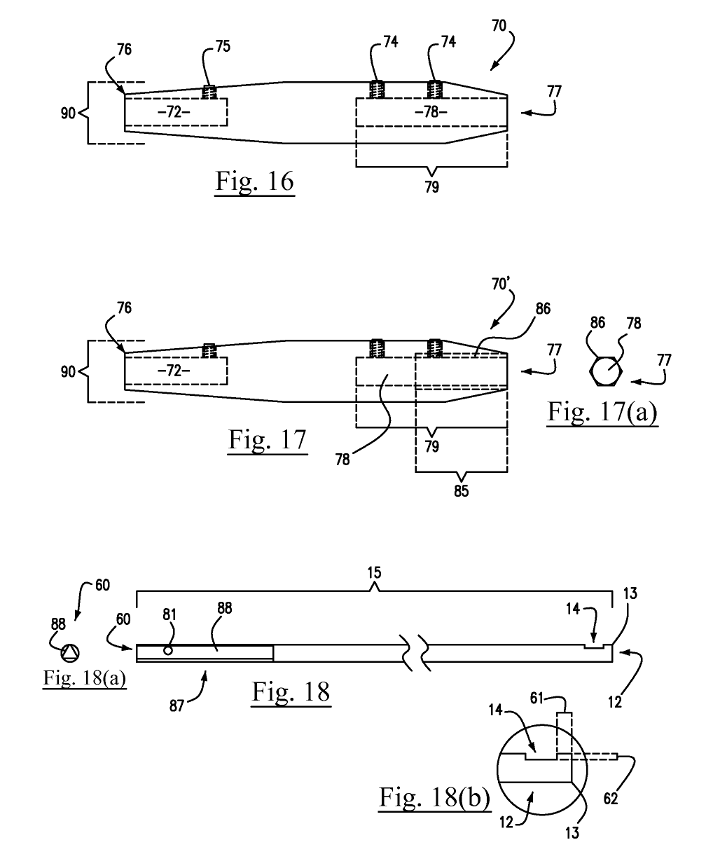

FIG. 16 depicts an extension adapter 70 usable in combination with a primary shank 10 having a shank diameter of 0.1875 inches, and FIG. 17 depicts an extension adapter 70′ usable in combination with (a) a primary shank 10 having a shank diameter of 0.25 inches, or (b) the secondary shank as at 71. Both adapters 70 and 70′ comprise inner adapter-based female structure as at 72 at the shank-engaging ends 76 and a similar outer adapter diameter as at 90, but differ at the ends 77 opposite the shank-engaging ends 76. In this regard, the adapter 70 preferably comprises a 0.25 inch diameter hole 78 drilled 1.25 inches deep as at 79.

By contrast, the adapter 70′ also preferably comprises a 0.25 inch diameter hole 78 drilled 1.25 inches deep as at 79, but includes a 0.25 inch hex form 86 broached 0.875 inches deep as at 85. FIG. 17(a) depicts an end view of the end 77 of the adapter 70′ showing the hex-round combination of attendant forms. The inner or left most set screws 74 in FIGS. 16 and 17 are preferably designed to meet the flat(s) 88 on a three flat shank end as at 87, and the outer or right most set screws 74 are designed to meet the groove 89 in a standard 0.25 inch quick change or secondary shank 71 or a flat 88 on a three flat shank end 87. The flats 88 are preferably ground into the shank 0.035 inches deep and 1.25 inches in length for optimum gripping with a three jaw chuck.

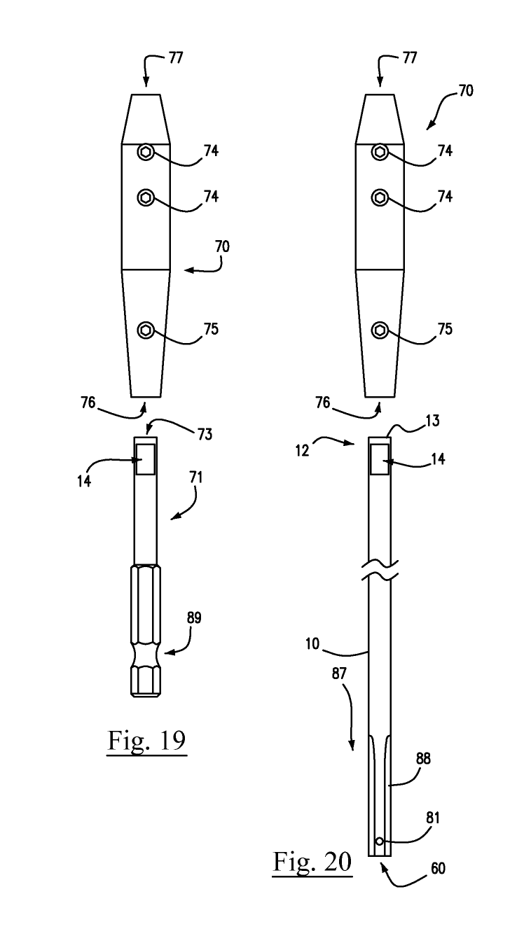

As indicated, it is contemplated that the drill bit system according to the present invention may further preferably comprise a quick change or secondary shank as at 71, which quick change or secondary shank 71 may preferably comprise certain shank structure identical to the bit-engaging end 12 as exemplified by a secondary bit-engaging end 73. The shank structure identical to the bit-engaging end 12 is believed embraced by the foregoing specifications and the fact that the specifications here call for an identical correspondence thereto. The extension adapter(s) 70/70′ are thus usable in combination with a select shank, which select shank may be selected from the group consisting of the primary shank 10 and the quick change or secondary shank 71 as generally and comparatively depicted in FIGS. 19 and 20.

The present invention thus essentially provides a drill bit system for enabling a user to quickly and easily interchange drill bits upon a shank during drilling operations for selectively extending the drillable depth through select materials. The drill bit system basically comprises a shank, at least two drill bits, and a set screw or similar other fastening means.

The shank has a bit-engaging end and a shank length extending from the bit-engaging end. The bit-engaging end has a shank tip and a notched portion adjacent the shank tip. The shank tip and shank length have a substantially uniform shank diameter as at 16. The notched portion preferably has a substantially uniform notch width.

Each drill bit according to the present invention preferably has a bit tip 26, a flute portion 27, a shank-engaging portion as at 40, and a bit axis 29. Each flute portion 27 preferably comprises a maximum flute diameter as at 41. Each shank-engaging portion preferably comprises a shank-engaging end as at 28. Each shank-engaging end 28 preferably has a shank end diameter as at 42.

Notably, each shank-engaging portion 40 preferably comprises a tapered outer bit surface as at 43, an inner female structure 31 for receiving the bit-engaging end 12, a threaded aperture as at 32, and a shank-receiving mouth 33 at the shank-engaging end 28. Each threaded aperture 32 preferably and respectively extends from the tapered outer bit surface 43 to the inner female structure 31 orthogonally relative to the bit axis 29.

Each female structure 31 preferably has a substantially uniform inner bit-receiving diameter as at 34 sized for receiving the shank diameter 16. Each maximum flute diameter 41 is respectively greater than each shank end diameter as at 42 and the shank diameter 16. As indicated each outer bit surface 43 is preferably tapered or sloped from the maximum flute diameter 41 to the shank end diameter 42 as perhaps most clearly depicted in FIGS. 4 and 5.

The set screw 11 or similar other fastening structure ore means preferably has a notch-engaging end, a tool-engaging end, and a threaded body extending intermediate the notch-engaging and tool-engaging ends. The threaded body has a maximal screw diameter as at 38, and the notch width 15 is preferably sized for receiving the maximal screw diameter 38.

The bit-engaging end is receivable by the shank-engaging ends of the various drill bits, and the set screw 11 is threadably receivable by the threaded apertures 32. The notch-engaging end is receivable by the notch 14. The set screw 11 removably and interchangeably fastens the drill bits 21 to the shank 10.

The maximum flute diameters 41 enable the user to bore into materials such as wood 100 and masonry 101 for forming material voids (as at 102) therein. The material voids 102 take on or comprise void diameters (as at 103) substantially and respectively equal to the maximum flute diameters 41. The tapered outer bit surface or surfacing 43 from the maximum flute diameter 41 to the shank end diameter 42 enables an entire select drill bit to pass through the material voids 102 in contrast to other prior art interchangeable drill bits as generally depicted in FIG. 11.

The shank diameter 16, being lesser than the maximum flute diameter 41, is thus also lesser than the void diameters 103, and thus the shank length may effectively function to selectively extend the drillable depth through said materials as generally and comparatively depicted in FIGS. 11-13.

While the above description contains much specificity, this specificity should not be construed as limitations on the scope of the invention, but rather as an exemplification of the invention. For example, it is contemplated that the present invention essentially provides a drill bit assembly comprising a shank, at least one primary drill bit, and certain means for removably fastening the drill bit to the shank, as preferably defined by a set screw.

The shank has a bit-engaging end, which bit-engaging end comprises a shank tip, a notched portion adjacent the shank tip, and an elongate shank length extending from the notched portion. The shank tip and shank length have a substantially uniform outer shank diameter, and the notched portion has a substantially uniform notch width.

The primary dill bit has a bit tip, a flute portion, a shank-engaging end, and a bit axis. The shank-engaging end has an outer bit surface, an inner female structure for receiving the bit-engaging end, a threaded bit aperture, and a shank-receiving mouth. The threaded bit aperture extends from the outer bit surface to the inner female structure orthogonally relative to the bit axis. The female structure has a substantially uniform inner bit diameter sized for receiving the outer shaft diameter.

The means for removably fastening the drill bit to the shank or set screw has a notch-engaging end, a tool-engaging end, and a threaded body extending intermediate the notch-engaging and tool-engaging ends. The threaded body has a maximal screw diameter. The notch width is sized for receiving the maximal screw diameter. The bit-engaging end is received by the primary shank-engaging end. The set screw is threadably received by the threaded aperture, and the notch-engaging end is received by the notch.

The foregoing specifications are further believed to support certain methodology for forming holes in a plurality of materials. The method may be said to comprise the steps of (1) providing (a) a primary shank and (b) at least one drill bit; (2) fastening a first select drill bit to the shank with a fastener via the fastener-receiving aperture; and (3) drilling through a first select material.

The primary shank has or comprises a bit-engaging end, a shank length, and a rotary source-engaging end. The bit-engaging end having a shank tip and a notched portion adjacent the shank tip, the shank length extending intermediate bit-engaging end and the rotary source-engaging end, the shank tip and shank length having a substantially uniform shank diameter, the shank tip having a tip width, the notched portion having a notch diameter and notch depth.

Each drill bit preferably has or comprises a flute portion, a shank-engaging portion, and a bit axis. Each flute portion comprises a maximum flute diameter, and each shank-engaging portion comprising a shank-engaging end, an outer portion surface, an inner bit-based female structure for receiving the bit-engaging end of the shank, a fastener-receiving aperture, and a shank-receiving mouth.

Each shank-engaging end has or comprises a shank end diameter, and each threaded aperture respectively extending from the outer portion surface to the inner bit-based female structure orthogonally relative to the bit axis for defining an inner aperture extent and an outer aperture extent, each inner bit-based female structure having (a) a substantially uniform inner bit diameter sized for receiving the shank diameter and (b) a shank-stopping terminus.

The shank-stopping terminus is preferably spaced from the inner aperture extent a distance equal to the tip width, the each maximum flute diameter being respectively greater than each shank end diameter and the shank diameter, each outer portion surface being tapered from the maximum flute diameter to the shank end diameter.

The maximum flute diameter of the first select drill bit enables the user to bore into the first select material for forming a first material void therein, the first material void having a first void diameter substantially equal to the maximum flute diameter of the first select drill bit. The shank diameter is thus preferably lesser than the first void diameter, and the shank length enables the user to selectively extend the drillable depth through the first select material.

Accordingly, although the invention has been described by reference to certain preferred and alternative embodiments, and certain methodology, it is not intended that the novel disclosures herein presented be limited thereby, but that modifications thereof are intended to be included as falling within the broad scope and spirit of the foregoing disclosure, the following claims and the appended drawings.

I claim:

1. A drill bit system for enabling a user to quickly and easily interchange drill bits upon a select shank construction during drilling operations for selectively extending the drillable depth through select materials, the drill bit system comprising:
a primary shank, the primary shank having a bit-engaging end, a shank length, and a rotary source-engaging end, the bit-engaging end having a shank tip and a notched portion adjacent the shank tip, the shank length extending intermediate the bit-engaging end and the rotary source-engaging end, the shank tip and shank length having a substantially uniform shank diameter, the shank tip having a tip width extending intermediate the bit-engaging end and the notched portion, the notched portion having a notch width and notch depth;
at least two select drill bits, each select drill bit having a bit tip, a flute portion, a shank-engaging portion, and a bit axis, each flute portion having a maximum flute diameter, each shank-engaging portion having a shank-engaging end, an outer portion surface, an inner bit-based female structure for receiving the bit-engaging end of the primary shank, a threaded aperture, and a shank-receiving mouth, each shank-engaging end having a shank end diameter, each threaded aperture respectively extending from the outer portion surface to the inner bit-based female structure orthogonally relative to the bit axis for defining an inner aperture extent and an outer aperture extent, each inner bit-based female structure having a substantially uniform inner bit diameter sized for receiving the shank diameter and a shank-stopping terminus, the shank-stopping terminus being spaced from the inner aperture extent a distance equal to the tip width, each maximum flute diameter being respectively greater than each shank end diameter and the shank diameter, each outer portion surface being tapered from the maximum flute diameter to the shank end diameter; and
a set screw, the set screw having a notch-engaging end, a tool-engaging end, and a threaded body extending intermediate the notch-engaging and tool-engaging ends, the threaded body having a maximal screw diameter, the notch width being sized for receiving the maximal screw diameter, the bit-engaging end being receivable by the shank-engaging ends, the set screw being threadably receivable by the threaded apertures, the notch-engaging end being receivable by the notched portion, the set screw thus for removably and interchangeably fastening the drill bits to the shank, the tip width being greater than the notch depth for minimizing torque-induced shank failure at a set screw-to-shank junction via the threaded aperture, the maximum flute diameters for enabling the user to bore into materials for forming material voids therein, the material voids having void diameters substantially and respectively equal to the maximum flute diameters, each tapered outer bit surface from the maximum flute diameter to the shank end diameter for enabling an entire select drill bit to pass through the material voids, and the shank diameter thus also being lesser than the void diameters, the shank length for selectively extending the drillable depth through said materials.

2. The drill bit system of claim 1 wherein the tip width is 0.075+0.005−0.000 inches (0.19+0.0127−0.000 cm) and the notch depth is 0.062 inches (0.157 cm).

3. The drill bit system of claim 2 wherein the primary shank is flexible, the flexible primary shank being heat-treated for allowing optimum flexibility and memory for drilling non-linearly through said select materials.

4. The drill bit system of claim 3 wherein the shank diameter is 0.1875 inches and the inner bit-receiving diameters are 0.190+0.002−0.000 inches.

5. The drill bit system of claim 3 wherein the shank diameter is 0.250 inches and the inner bit-receiving diameters are 0.253+0.002−0.000 inches.

6. The drill bit system of claim 3 comprising an extension adapter, the extension adapter having an inner adapter-based female structure identical to the inner bit-based female structure, the inner adapter-based female structure for receiving structure identical to the bit-engaging end.

7. The drill bit system of claim 6 comprising a secondary shank, the secondary shank having shank structure identical to the bit-engaging end, the extension adapter thereby being usable in combination with a select shank, the select shank being selected from the group consisting of the primary shank and the secondary shank.

8. A drilling system, the drilling system for enabling a user to quickly and easily interchange at least one drill bit upon a select shank construction during drilling operations for selectively extending the drillable depth through select materials, the drill bit system comprising:
a primary shank, the primary shank having a bit-engaging end, a shank length, and a rotary source-engaging end, the bit-engaging end having a shank tip and a notched portion adjacent the shank tip, the shank length extending intermediate the bit-engaging end and the rotary source-engaging end, the shank tip and shank length having a substantially uniform shank diameter, the shank tip having a tip width extending intermediate the bit-engaging end and the notched portion, the notched portion having a notch diameter and notch depth;
at least one select drill bit, the at least one select drill bit having a bit tip, a flute portion, a shank-engaging portion, and a bit axis, each flute portion having a maximum flute diameter, each shank-engaging portion having a shank-engaging end, an outer portion surface, an inner bit-based female structure for receiving the bit-engaging end of the primary shank, a fastener-receiving aperture, and a shank-receiving mouth, each shank-engaging end having a shank end diameter, each fastener-receiving aperture respectively extending from the outer portion surface to the inner bit-based female structure orthogonally relative to the bit axis for defining an inner aperture extent and an outer aperture extent, each inner bit-based female structure having a substantially uniform inner bit diameter sized for receiving the shank diameter and a shank-stopping terminus, each shank-stopping terminus being spaced from the inner aperture extent a distance equal to the tip width, each maximum flute diameter being respectively greater than each shank end diameter and the shank diameter, each outer portion surface being tapered from the maximum flute diameter to the shank end diameter; and
a fastener, the fastener having a notch-engaging end, a tool-engaging end, and a fastener body extending intermediate the notch-engaging and tool-engaging ends, the fastener body having a maximal fastener diameter, the notch width being sized for receiving the maximal fastener diameter, the bit-engaging end being receivable by each shank-engaging end, the fastener being receivable by each fastener-receiving aperture, the notch-engaging end being receivable by the notched portion, the fastener thus for removably and interchangeably fastening each select drill bit to the primary shank, the tip width being greater than the notch depth for minimizing torque-induced shank failure at a fastener-to-shank junction via the fastener-receiving aperture, the maximum flute diameter for enabling the user to bore into materials for forming material voids therein, the material voids having void diameters substantially and respectively equal to the maximum flute diameter, each tapered outer bit surface from the maximum flute diameter to the shank end diameter for enabling an entire select drill bit to pass through the material voids, and the shank diameter thus also being lesser than the void diameters, the shank length for selectively extending the drillable depth through said select materials.

9. The drill bit system of claim 8 wherein the tip width is 0.075+0.005−0.000 inches and the notch depth is 0.062 inches.

10. The drill bit system of claim 8 wherein the primary shank is flexible, the primary shank being heat-treated for allowing optimum flexibility and memory for drilling non-linearly through said select materials.

11. The drill bit system of claim 8 wherein the shank diameter is 0.1875 inches and each inner bit diameter is 0.190+0.002−0.000 inches.

12. The drill bit system of claim 8 wherein the shank diameter is 0.250 inches and each inner bit diameter is 0.253+0.002−0.000 inches.

13. The drill bit system of claim 8 comprising an extension adapter, the extension adapter having an inner adapter-based female structure identical to the inner bit-based female structure, the inner adapter-based female structure for receiving structure identical to the bit-engaging end.

14. The drill bit system of claim 13 comprising a secondary shank, the quick change shank having shank structure identical to the bit-engaging end, the extension adapter thereby being usable in combination with a select shank, the select shank being selected from the group consisting of the primary shank and the secondary shank.

15. A method for forming holes in select materials, the method for forming holes in select materials comprising the steps of:
providing a primary shank, the primary shank having a bit-engaging end, a shank length, and a rotary source-engaging end, the bit-engaging end having a shank tip and a notched portion adjacent the shank tip, the shank length extending intermediate the bit-engaging end and the rotary source-engaging end, the shank tip and shank length having a substantially uniform shank diameter, the shank tip having a tip width extending intermediate the bit-engaging end and the notched portion, the notched portion having a notch diameter and notch depth;
providing at least one select drill bit, each select drill bit having a flute portion, a shank-engaging portion, and a bit axis, each flute portion having a maximum flute diameter, each shank-engaging portion having a shank-engaging end, an outer portion surface, an inner bit-based female structure for receiving the bit-engaging end of the primary shank, a fastener-receiving aperture, and a shank-receiving mouth, each shank-engaging end having a shank end diameter, each fastener-receiving aperture respectively extending from the outer portion surface to the inner bit-based female structure orthogonally relative to the bit axis for defining an inner aperture extent and an outer aperture extent, each inner bit-based female structure having a substantially uniform inner bit diameter sized for receiving the shank diameter and a shank-stopping terminus, each shank-stopping terminus being spaced from the inner aperture extent a distance equal to the tip width, the each maximum flute diameter being respectively greater than each shank end diameter and the shank diameter, each outer portion surface being tapered from the maximum flute diameter to the shank end diameter;
fastening a first select drill bit to the shank with a fastener via the fastener-receiving aperture; and
drilling through a first select material via the first select drill bit, the tip width being greater than the notch depth for minimizing torque-induced shank failure at a fastener-to-shank junction via the fastener-receiving aperture, each maximum flute diameter for enabling the user to bore into select materials for forming material voids therein, the material voids having void diameters substantially and respectively equal to the maximum flute diameter(s), each tapered outer bit surface from the maximum flute diameter to the shank end diameter for enabling an entire select drill bit to pass through the material voids, the shank diameter thus also being lesser than the void diameters, the shank length for selectively extending the drillable depth through said select materials.

16. The method of claim 15 wherein the tip width is 0.075+0.005−0.000 inches and the notch depth is 0.062 inches.

17. The method of claim 15 wherein the shank diameter is 0.1875 inches and each inner bit diameter is 0.190+0.002−0.000 inches.

18. The method of claim 15 wherein the shank diameter is 0.250 inches and each inner bit diameter is 0.253+0.002−0.000 inches.

19. The method of claim 15 comprising the step of providing an extension adapter, the extension adapter having an inner adapter-based female structure identical to the inner bit-based female structure, the inner adapter-based female structure for receiving structure identical to the bit-engaging end.

20. The method of claim 19 comprising the step of providing a secondary shank, the secondary shank having shank structure identical to the bit-engaging end, the extension adapter thereby being usable in combination with a select shank, the select shank being selected from the group consisting of the primary shank and the secondary shank.
